(19) United States
(12) Patent Application Publication
(10) Pub. No.: US 2017/0080901 A1
(43) Pub. Date: Mar. 23, 2017

(54) WINDSCREEN WIPER UNIT COMPRISING AN ARTICULATED COVER

(71) Applicant: Valeo Systémes d'Essuyage, Le Mesnil Saint Denis (FR)

(72) Inventors: Stéphane Houssat, Blanzat (FR); Eric Poton, Pont Du Chateau (FR); Vincent Gaucher, Ennezat (FR)

(73) Assignee: Valeo Systémes d'Essuyage, Le Mesnil Saint Denis (FR)

(21) Appl. No.: 15/271,309

(22) Filed: Sep. 21, 2016

(30) Foreign Application Priority Data
Sep. 23, 2015 (FR) 1558970

(51) Int. Cl. B60S 1/04; B60S 1/40; B60S 1/38

(52) U.S. Cl. CPC B60S 1/0491; B60S 1/381; B60S 1/4006; B60S 1/3874; B60S 1/3886; B60S 2001/3843; B60S 2001/4035

(57) ABSTRACT

Wiper unit (2), in particular for a windscreen wiper, comprising a body (2′) and an articulated cover (28a), which can be displaced between two positions (P1, P3) opposite the body (2′), characterized in that it comprises stop means (30, 31a, 31b, 27b, 283a2′) which define an end of course position (P3) of the cover (28a).

### TECHNICAL FIELD

The present invention relates to a windscreen wiper unit, and in particular to a windscreen wiper comprising an articulated cover, in particular a connection arm/wiper unit provided with a cover of this type. It also relates to a windscreen wiper provided with the said unit.

### PRIOR ART

Typically, a windscreen wiper for a window such as the windscreen of a motor vehicle comprises a wiper blade, generally made of rubber, which is designed to rub against the window of the vehicle in order to discharge water by bringing it out of the field of vision of the driver. The wiper additionally comprises a longitudinal vertebra which rigidifies the wiper blade, such as to assist the application of this blade on the windscreen, as well as a support fitting for the vertebra and the blade. The wiper also comprises a longitudinal cover unit comprising an upper aerodynamic deflector, which is designed to improve the placing of the wiper on the windscreen, and thus the aerodynamic performance of the system.

The wiper is attached to an arm by an assembly consisting of a mechanical connector and an adapter. The connector is a part which is secured directly on the structure of the wiper, the adapter being an intermediate part which permits the securing of the connector on the arm of the windscreen wiper. These two parts are connected to one another by a transverse shaft which permits their relative rotation.

When the wiper is designed to be attached to an arm of the hook type, the connector is provided with a hole through which the end of the arm passes. The hole must be long enough to be able to insert into it the adapter, then the arm on which the latter is secured. However, after putting these elements into place, the remaining opening of the hole is found to be detrimental, both for aesthetic reasons and for aerodynamic reasons, with the hollow of the hole being able to create turbulence in the air which circulates on the windscreen. It is thus known to install one or a plurality of closure covers which are articulated with the connector, typically with rotation, and which cover the hole and close the upper face of the connector in order to form a covered connector.

When the cover has an opening which is too large, for example as a result of rapid or sudden opening, the articulation of the cover can be damaged or even broken, which makes the cover unusable.

The objective of the present invention is to eliminate these disadvantages by proposing a windscreen wiper unit comprising an articulated cover wherein the articulation of the cover is made secure.

### SUMMARY OF THE INVENTION

The invention thus relates to a wiper unit, in particular for a windscreen wiper, comprising a body and an articulated cover, which can be displaced between two extreme positions opposite the body.

The wiper unit according to the invention comprises stop means which define an end of course position of the cover, the said end of course position being intermediate between the two extreme positions.

Thus, advantageously, the stop means make it possible to block the course of the cover, in the direction of the opening of the cover, and in an intermediate position between the two extreme positions, between which the cover would be displaced in the absence of such stop means. This intermediate blocking of the cover makes it possible to limit the course of the cover, and thus prevent damage to the articulation of the cover.

The course of the cover can be blocked by any appropriate stop means, for example by supporting the cover on a stop which is placed on the exterior or in the interior of the body, or on a stop which is arranged on a rotational shaft of the cover.

The body can comprise a hole which is designed to be covered at least partly by the cover, and is extended, for example longitudinally, by a cut-out in which a rotational shaft of the cover is positioned.

According to a first embodiment, the stop means comprise at least one stop projecting on the body.

The said at least one projecting stop can be arranged spaced apart from the cut-out.

The said at least one projecting stop can be arranged on the side opposite the hole.

According to a second embodiment, the stop means comprise en arm of the cover which cooperates with a stop means of the body.

The arm can have a curved end which can be supported against or below the stop means of the body during the opening of the cover.

The said stop means of the body can be arranged inside the hole, on an inner wall of the body.

The cover can be provided with two lateral arms which each cooperate with a stop means of the body.

According to a third embodiment. the stop means comprise stop means of a rotary articulation element of the cover which cooperates with stop means of a rotational shaft of the cover.

The rotational shaft of the cover can comprise a cylindrical portion and projecting stop means on the cylindrical portion.

The rotational shaft of the cover can comprise a cylindrical portion and two stops each arranged at a lateral end of the shaft.

The cover can comprise a rotary articulation element provided with a first cylindrical portion arranged between the two stops of the rotational shaft, and a second cylindrical portion which can abut the two stops of the rotational shaft.

Each stop of the rotational shaft can comprise a first face, which is situated on the cut-out side, and is substantially orthogonal to the longitudinal axis of the hole, the said first face being designed to block an end surface of the second cylindrical portion in rotation in the direction of opening of the cover.

Each stop of the rotational shaft can additionally comprise a second face, which is situated on the hole side, and is substantially orthogonal to the longitudinal axis of the hole, the said second face being designed to block the other end surface of the second cylindrical portion in rotation in the direction of closure of the cover.

The unit can be a unit for connection of the wiper to a wiper arm. In particular, the unit can be a central fitting of a flat streamlined windscreen wiper. Flat streamlined wiper means a flat wiper equipped with a streamlined portion. A streamlined portion means exterior equipment which in general is profiled.

The invention also relates to a windscreen wiper comprising a unit as described above.

The windscreen wiper can comprise a streamlined portion comprising two end covers and a central fitting which is situated between the two end covers, each end cover being articulated relative to the central fitting.

### DESCRIPTION OF THE FIGURES

The invention will be better understood, and other details, characteristics and advantages of it will become apparent from reading the following description, provided by way of non-limiting example, and with reference to the appended drawings in which:

FIG. 1 is a schematic view in perspective of a flat streamlined wiper, in the free state without constraint;

FIG. 2 is a schematic view in perspective of the wiper in FIG. 1 when it is supported on a window, in particular of a vehicle;

FIG. 3 is a schematic exploded view in perspective of the wiper in FIG. 1;

FIG. 4 is a schematic view in perspective of a fitting of the wiper;

FIG. 5 is a view on an enlarged scale of part of the fitting in FIG. 4, and shows removable means for connection and rigidification;

FIG. 6 corresponds to FIG. 5, and shows a step of preparation of the fitting, in which one of the means for connection and rigidification has been removed;

FIG. 7 is a schematic view in perspective of a covered fitting of the wiper;

FIGS. 8 to 10 and 13 are partial schematic views in perspective of the covered fitting in FIG. 7, FIGS. 11 and 14 are schematic views in perspective of covers of this covered fitting, and FIG. 12 is a view from above of the fitting alone without a cover;

FIG. 15 is a partial view in perspective of a covered fitting according to the prior art;

FIGS. 16 and 17 are partial views in perspective of a covered fitting according to the invention, according to a first embodiment;

FIG. 18 is a partial view in perspective of a covered fitting according to the invention, in accordance with a second embodiment: and

FIGS. 19 to 22 are partial views in perspective of a covered fitting according to the invention, in accordance with a third embodiment.

### DETAILED DESCRIPTION

Hereinafter in the description, the terms longitudinal or lateral refer to the orientation of the windscreen wiper according to the invention. The longitudinal direction corresponds to the main axis of the wiper along which it extends, whereas the lateral orientations correspond to intersecting straight lines, i.e. which intersect the longitudinal direction, and in particular are perpendicular to the longitudinal axis of the wiper on its rotational plane. For the longitudinal directions, the terms exterior or interior are understood to be relative to the point of securing of the wiper on a wiper arm, with the term interior corresponding to the part where the arm and a half-wiper extend. Finally, the directions with the references upper or lower correspond to orientations perpendicular to the rotational plane of the windscreen wiper, with the lower reference containing the plane of the windscreen.

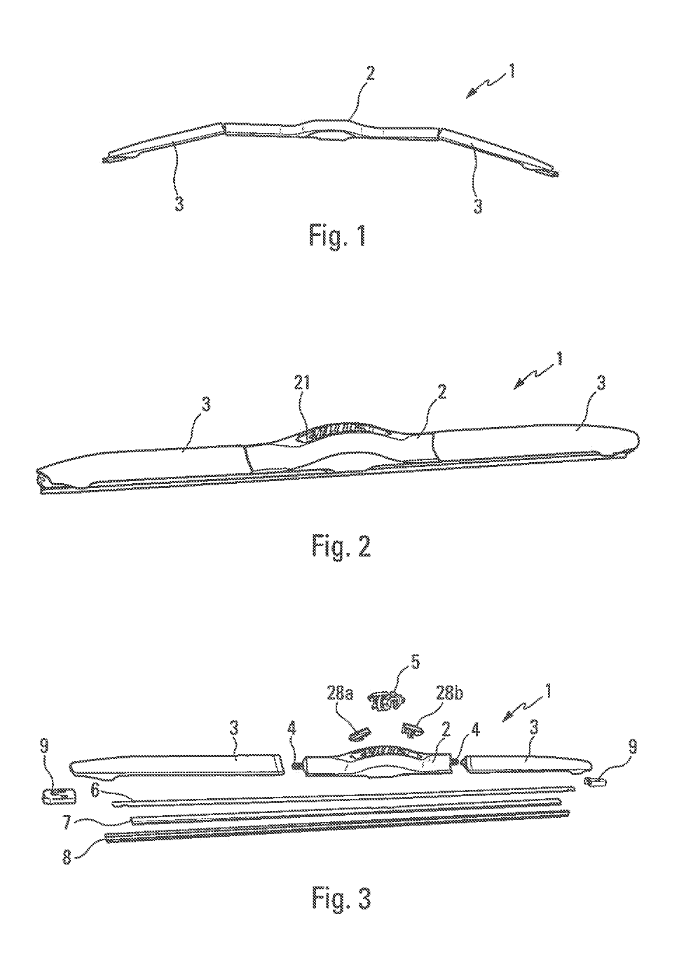

With reference to FIGS. 1 to 6, the elements which are identical or functionally equivalent are identified by identical reference numbers.

FIG. 1 illustrates a windscreen wiper 1 in particular for a motor vehicle windscreen, the wiper 1 being a flat streamlined wiper, i.e. a flat wiper equipped with streamlined portion, the flat streamlined wiper 1 in this case being in a free position in space, without any constraint.

The upper part of the wiper 1 is formed by the streamlined portion comprising an aerodynamic form which deflects upwards the air which reaches the windscreen. The streamlined portion thus forms an aerodynamic deflector. The aforementioned deflexion of the air generates a support force for the wiper 1 on the windscreen, which, in association with a second support force generated by a pressure of the arm, guarantees permanent contact on the windscreen, and therefore reliable wiping.

This streamlined portion has substantially the fowl of a dihedron formed by two longitudinal was which join at the upper part at a top ridge, with the front wall having a hollow aerodynamic form, whereas the rear wall is substantially flat in the example represented. The interior of the dihedron is hollow, such as to leave space to accommodate in it elements which form a wiping unit of a flat wiper, which will be described in detail hereinafter.

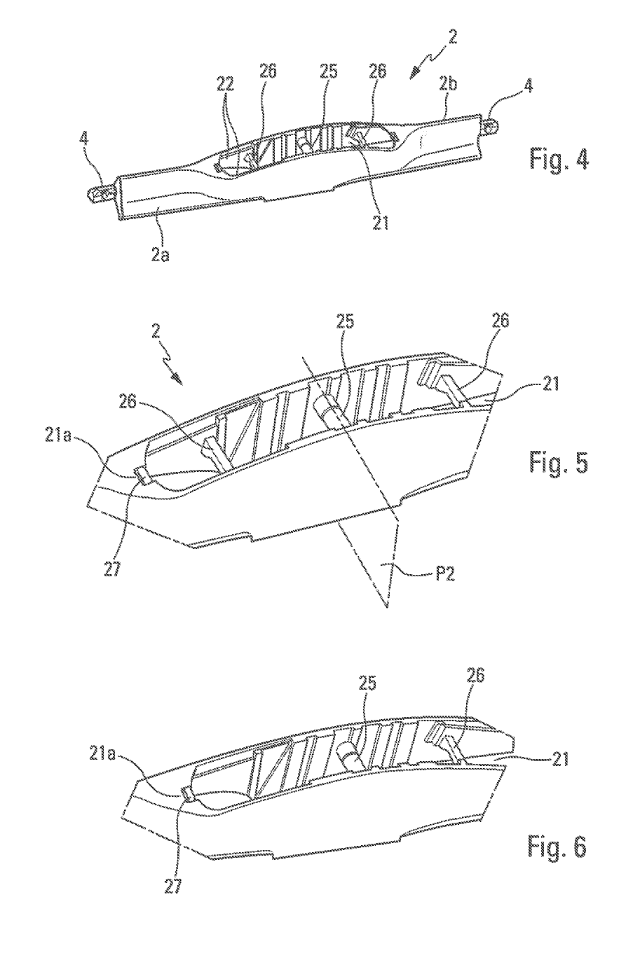

The streamlined portion is made in three parts which are articulated with one another. The central part, which is known hereinafter as the central fitting 2, fulfils the functions of a connector for a non-streamlined flat wiper, i.e. it is to this fitting that there are coupled the various elements which extend along the entire length of the wiper 1. With the exception of its centre, which has substantially parallel vertical walls, in order to be able to accommodate an adapter between them, this central fitting 2 has the streamlined aerodynamic deflector form described above. It thus comprises two longitudinal lateral was 2a, 2b (FIG. 4), the upper longitudinal edges of which are connected to one another such that the said walls form substantially a dihedron. On this central fitting there are attached two parts in eccentric longitudinal positions, known hereinafter as end covers 3. These two covers also have the streamlined aerodynamic deflector form along their entire length. Each cover 3 thus comprises two longitudinal lateral walls, the upper longitudinal edges of which are connected to one another, such that the said walls form substantially a dihedron.

A first end cover 3 extends towards the interior, whereas the second extends towards the exterior. The connection between the central fitting 2 and each of the end covers 3 is an articulation which pivots around a shaft oriented according to a lateral or transverse direction, such that the two end covers 3 are displaced on a plane perpendicular to the rotational plane of the wiper. The break which is thus created between the central fitting 2 and the end covers 3 prevents the outer and inner ends of the wiper from being applied against the windscreen with a pressure lower than that which is exerted at the central fitting, because of a longer distance of their point of support relative to the point of coupling of the drive arm on the wiper.

The central part of the central fitting 2 has a height which is greater than the rest of the wiper, because of its function as a connector, which makes it possible to accommodate in it means for connection of the wiper to the drive arm, and in particular an adapter.

FIG. 2 shows the same wiper 1 in a position supported against a window, presented here for the sake of simplification in the form of a flat surface. The articulations between the central fitting 2 and the two end covers 3 are closed, i.e. these covers are positioned on the axis of the central fitting, with the upper surfaces of these three parts forming a continuous streamlined surface. The central part of the central fitting 2 comprises a hole 21 through which the end of a drive arm passes, and comprises a transverse shaft on which there is secured the adapter (not represented) which ensures the attachment of the wiper 1 on the arm.

FIG. 3 shows the wiper 1 in exploded view. The central fitting 2 comprises longitudinally on both sides two means for connection or articulation comprising fingers 4 which extend longitudinally from the body of the fitting. These fingers 4 comprise an orifice which is designed to receive an articulation shaft supported by the corresponding and cover 3. The cooperation of this articulation shaft with the orifice in the finger 4 permits the rotation of the cover 3 relative to the central fitting 2, on a plane perpendicular to the rotational plane of the wiper 1.

Below these elements are represented respectively a rigidification vertebra 6, a unit 7 for maintenance or retention, and a wiper blade 8, the assembly of these three elements forming what will be known hereinafter as a wiper unit. The rigidification vertebra 6 serves the purpose of acting as a structure for the wiper, by providing it with a curved form which corresponds to the average shape of the windscreen on which the wiper is displaced. As for a conventional flat wiper, its longitudinal rigidity makes it possible to maintain sufficient pressure at the two ands of the wiper, such that the wiping is carried out regularly on the entire surface to be wiped.

The retention unit 7 constitutes the support element both for the rigidification vertebra 6 and the wiper blade 8.

The wiper blade 8 is a conventional blade made of elastomer material, which is supported by the retention unit 7, and serves the purpose of remaining in permanent contact with the windscreen.

FIG. 3 also shows two end joining pieces 9, which serve the purpose of joining the three preceding elements at their end, and blocking them longitudinally. Each end joining piece 9 also has a longitudinal stop, against which there is supported a support face supported by the corresponding end cover 3. This cooperation of the longitudinal stop and the support face of the cover prevents the three elements of the wiper unit from extending longitudinally when the cover pivots relative to the central fitting 2, and thus forces them to curve so that they follow the curvature of the windscreen.

With reference now to FIGS. 4 to 6, the interior of the hole 21 in the central fitting 2 can be seen, which hole extends longitudinally between the lateral walls 2a, 2b of this fitting, and is delimited longitudinally by two parallel walls 22. On both sides of the hole 21, there extend the front 2a and rear 2b walls, which are longitudinal with reference to the direction of circulation of the air. A transverse articulation shaft 25 connects the two parallel lateral was 22, such as to support the adapter 5, which is secured from above by snapping in or resilient snapping in.

As a result of the relatively long length of the hole 21, the portions of lateral walls 22 which are situated at the hole can have a certain fragility when they are manipulated. It is thus advantageous to add means 26 for connection and rigidification between the inner lateral faces 22 of the hole 21, in this case in the form of cross-members 26, which each have the form of an elongate bar. As represented, these cross members 26 extend parallel to the articulation shaft 25, whilst being positioned substantially at the same height as this shaft, and substantially in the middle of the distance which exists between the shaft 25 and the longitudinal end of the hole 21. These cross-members 26 are formed by bridges of material which connect the two lateral faces 22. In this case they are of the detachable type, i.e. they can be removed. They can be breakable, or can be cut out, or dismantled, and in particular they can be unclipped. In this case they have breakable sections, i.e. an area of fragility or portion of weakness at each of their ends, such that they can be broken at the faces 22, without leaving a protuberance which would interfere with the rotation of the adapter 5. In fact, the presence of two cross-members 26 on a single central fitting 2, which corresponds to a configuration at the output from production, is not suitable for putting a central fitting of this type into service, since one of them would restrict unduly the rotation of the adapter 5. When fitting a windscreen wiper, it is necessary to choose in which direction this fitting will be installed on the wiper arm. Depending on this choice, one of the cross-members 26 is broken, which provides the arm and its adapter 5 with the necessary freedom of rotation in the central fitting. As is seen in FIG. 6, the second cross-member is retained, since it does not interfere with this rotation. There is therefore simplification in the production of the central fittings 2 and of their logistics, since this is a single model which adapts to all directions of fitting of a windscreen wiper, by means of previous breaking of one of the two cross-members 26. The presence of the two cross-members 26, then a single one, provides the parallel lateral walls 22 with the necessary rigidity, firstly during transport to take them to the place of assembly, then during their use on a windscreen. The two cross-members 26 are in this case arranged symmetrically relative to the transverse plane P2 which passes substantially through the middle of the hole 21 and via the shaft 25.

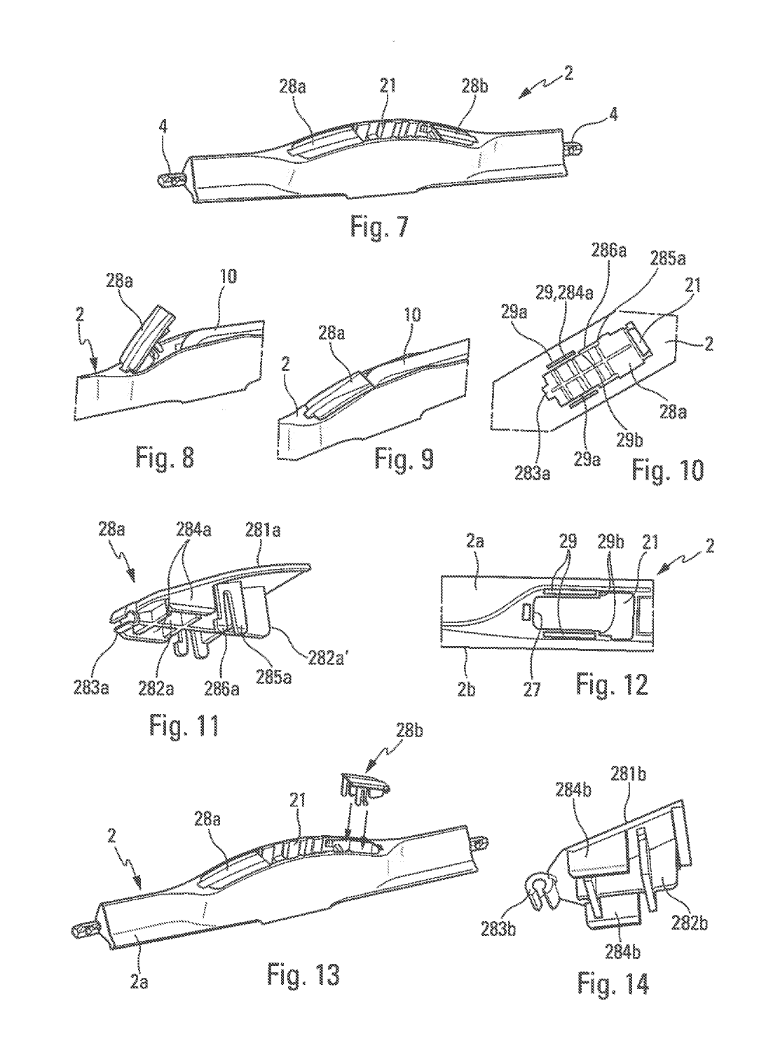

In addition, at each of its longitudinal ends, the hole 21 has a substantially transverse cut-out 21a, which extends the cut-out in the hole 21 longitudinally. In this cut-out 21a there is positioned a transversely oriented shaft 27, which can act as a rotational shaft or support shaft for a closure cover, as will be explained hereinafter with reference to FIGS. 7 to 14.

FIG. 7 shows a central fitting 2 in which the hole 21 is partly closed by two closure covers 28a and 28b. In fact, whereas the hole 21 must be long enough to be able to insert in it an adapter 5 then the arm on which the latter is secured, its opening at the top is found to be detrimental after these elements have been put into place, both for aesthetic and aerodynamic reasons, with the hollow of the hole being able to create turbulence in the air which circulates on the windscreen. It is thus recommended to install two closure covers 28a, 28b which cap the hole 21, and partly close the upper face of the central part of the central fitting 2. Take into account the presence of the arm and the adapter 5, which do not have symmetry according to a transverse plane, the two ends of the hole 21 are neither identical nor symmetrical. There is therefore a distinction between a front closure cover 28a, which is positioned towards the exterior relative to the wiper arm, and a rear closure cover 28b, which is positioned on the interior side. Thus, a first streamlined portion 28a is configured to dose a first longitudinal end part of the hole 21, and the second streamlined portion 28b is configured to dose a second longitudinal end part of the hole, opposite the first part.

These covers can be put into place in two different ways. As represented in the figures, the front cover 28a is fitted such as to be mobile in rotation around the shaft 27 of the front cut-out 21a, whereas the rear cover 28b is fitted fixed on the shaft 27 which passes through the rear cut-out 21a.

FIGS. 8 and 9 thus show the capacity for rotation of the front cover 28a around its shaft 27. In FIG. 8, the front cover 28a is raised, and shows the longitudinal space which is left clear in order to permit the insertion of the arm 10 in the hole 21, and its passage around the adapter 5. FIG. 9 shows the front cover 28a closed, and the continuity of the surfaces between the upper face of the central fitting 2, the front cover 28a, and the wiper support arm 10. Finally, FIG. 10 shows in a view from below the front cover 28a in position in the hole 21.

FIG. 11 shows in greater detail the form of the front cover 28a. It comprises an upper face 281a, the form of which (which in this case is not flat) is formed such as to extend the form of the upper face of the central fitting 2, and to provide aerodynamic continuity between these two elements. The lower face 282a is formed by strengtheners which are crossed such as to provide the part with rigidity, and extend vertically until they meet the upper face 281a. At the front, i.e. towards the exterior of the wiper, the upper face 281a ends in a transverse cylinder 283a, which is open on a sector with a limited amplitude. For its inner diameter, this cylinder has a value which is slightly greater than that of the shaft 27, such that the shaft 27 can act as a rotational shaft for the front cover; the opening sector of this cylinder is such that the shaft 27 can pass into this sector by resilient snapping in, and remain there after the snapping in. Finally, on the sides of the front cover 28a, two vertically oriented lugs 284a can be seen which extend from the upper face 281a. At the rear of these two lugs 284a, two second lugs 285a also extend vertically. At each side of the streamlined portion, between the lugs 284a, 285a, a hook 286a also extends, also projecting vertically. The hooks 286a are resiliently deformable, and are designed to cooperate by resilient snapping in with a complementary means of the fitting 2.

FIG. 10 shows the first two lugs 284a which open into the hole 21, and are fitted into guides or recesses 29 in the hole 21. These guides are formed firstly by the lateral faces 22 of the central part of the central fitting 2, and secondly by partitions 29a parallel to these faces, offset towards the interior of the hole 21, these parallel partitions 29a being attached by small partitions 29b transverse to the lateral faces 22, in order to close the recess which forms a guide. The first lugs 284a are used to position the cover 28a in the hole 21. The hooks 286a cooperate with the lower ends of the partitions 29b, in order to ensure the locking of the cover in its fitting position.

In addition, the longitudinal end of one of the strengtheners of the cover 28a, opposite the cylinder 283a, forms a means 282a′ for support and retention of the adapter 5 sand/or of the arm 10.

FIG. 12 shows the hole 21 without the rear cover, FIG. 14 shows the rear cover 28b alone, and FIG. 13 shows the rear cover 28b just before it is put into place in the hole 21. Since the elements of the rear cover 28b have the same function as similar elements of the front cover 28a, they are designated by the same numerical references, with the letter a being replaced by a letter b; they are not described again.

FIG. 13 shows the direction in which this cover is put into place. Whereas the front cover 28a was attached to a shaft 27 and was mobile in rotation around it, the rear cover 28b is implanted by means of vertical translation, in order to be positioned by snapping in, in a fixed manner. As a result, as can be seen in FIG. 14, the cylinder 283b of the rear cover has an open sector, the opening of which is oriented downwards. Rotation around this shaft 27 is prevented by the presence of the first lugs 284b, the side of which opposite the cylinder 283b co-operates along its entire height with the small transverse partition 29b, and blocks any rotation. Consequently, the presence of hooks is no longer necessary. Similarly, the end of the hole 21, which is illustrated in FIG. 12, is simplified in comparison with that in FIG. 10, and comprises only a guide 29 for accommodation of the first lugs 284b alone.

Although the rear cover 28b has been described as being fitted fixed on the shaft 27 which passes through the rear cut-out, it is also possible to envisage using a rear cover 28b which is mobile in rotation, like the front cover 28a.

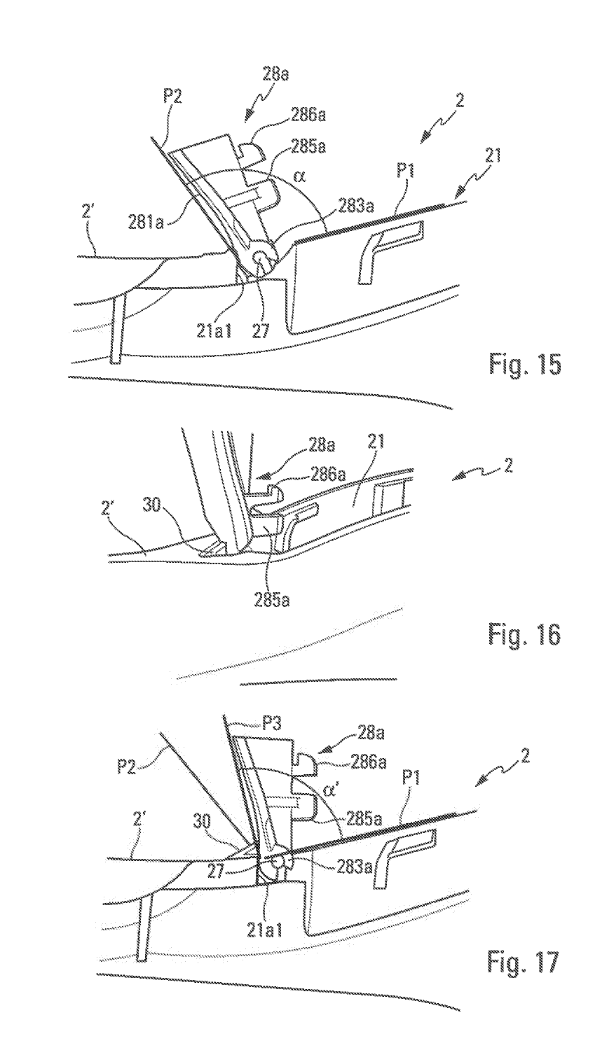

As illustrated in FIG. 15, the front cover 28a is mobile in rotation between two extreme positions, i.e. a first position P1, which is the closed position of the cover 28a, in which the upper face 281a of the cover 28a is substantially aligned with the upper surface of the hole 21, and a position P2 in which the cover 28a is completely open, and in which the upper face 281a of the cover 28a is supported against the rear face 21a1 of the cut-out 21a, and in particular against the upper ridge of the face 21a1, the rear face 21a1 being substantially orthogonal to the longitudinal axis of the fitting 2. The angle between the positions P1 and P2 is the angle α.

According to the invention, the fitting 2 is provided with stop means which define an end of course position of the cover 28a, the said end of course position being intermediate between the closed position P1 and the completely open position P2. The stop means make it possible to block the cover 28a in the direction of opening of the cover 28a, i.e. during its spacing from the hole 21.

As represented in FIG. 15, in this embodiment the cover 28a is provided only with hooks 286a and with the two second lugs 285a, the first lugs 284a having been removed. In addition, each second lug 285a is interposed between the cylinder 283a and a hook 286a.

According to a first embodiment, as illustrated in FIGS. 16 and 17, the stop means comprise at least one stop 30 projecting on the body 2′ of the fitting 2, for example on the upper surface of the body 2′. The stop 30 is arranged in the vicinity of the cover 28a, in the vicinity of the hole 21, and spaced apart from the cut-out 21a. The stop 30 is in the form of a substantially straight, or slightly curved rib, on which the cover 28a is stayed. The stop 30 is inclined relative to the upper surface of the body 2′, with the length of the stop 30 and its angle of inclination being able to be adjusted according to the required end of course position of the cover 28a. For the sake of greater clarity, the cover 28a is represented partially in FIGS. 15 to 17.

Thus, thanks to the stop 30, the end of course position P3 of the cover 28a is intermediate between the position P1 and the position P2 (FIG. 17). The opening of the cover 28a is blocked according to a predefined angle α′ which is smaller than the angle α, and the rotary articulation element 283a of the cover 28a is thus protected.

According to a variant of this first embodiment, instead of projecting from the fitting 2, the stop 30 can be incorporated in the cover 28a, and in particular in its upper surface 281a.

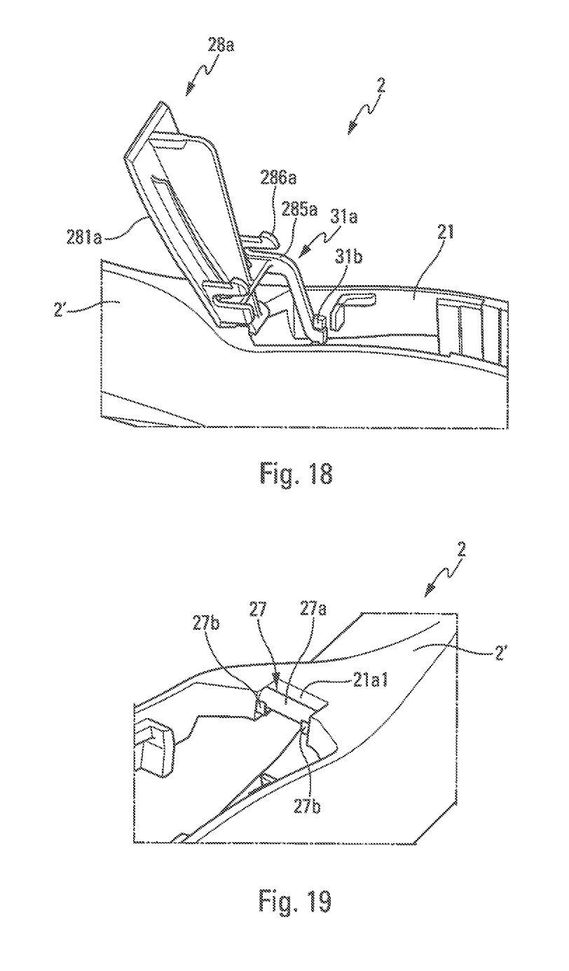

According to a second embodiment, as illustrated in FIG. 18, and which can be combined with the first embodiment, the stop means comprise at least one lug 31a (or arm) of the cover 28a which cooperates with a stop 31b of the fitting 2, in order to block the rotation of the cover 28a. The cover 28a can comprise two lugs 31a arranged on both sides of the cover 28a, each lug 31a being connected at one of its ends to the upper face 281a of the cover 28a, and cooperating at its other end with a stop 31b of the fitting 2. Each lug 31a constitutes a coupling element substantially in the form of an “S”, which abuts against or below the stop 31b during the opening of the cover 28a. Each lug 31a can be an extension of a second lug 285a of the cover 28a in FIG. 15. Each lug 31a can thus comprise three parts, i.e. a lug 285a which is connected to the cover 28a, a substantially straight central part, and an end hook. The stop 31b is advantageously arranged on an inner lateral wall of the fitting 2, inside the hole 21, and below the upper surface of the fitting 2.

Thus, whereas in the first embodiment the stop 30 was situated on the exterior of the fitting 2, the stop 31b in the second embodiment is in this case arranged in the interior of the fitting 2.

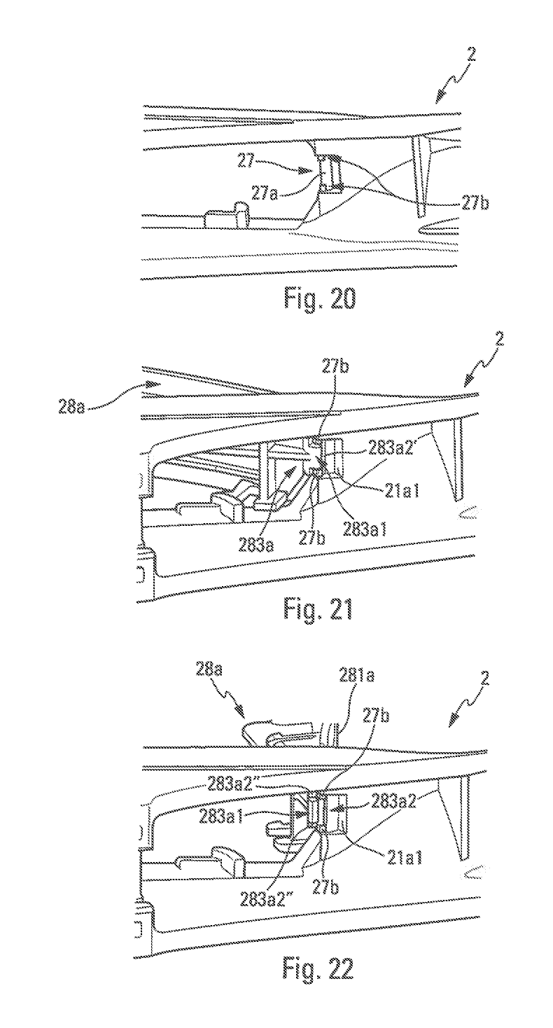

According to a third embodiment, as illustrated in FIGS. 19 to 22, and which can be combined with the first and/or the second embodiment, the stop means are associated with the rotational shaft 27 of the cover 28a. The rotational shaft 27 comprises a cylindrical part 27a which is designed to ensure the rotation of the cover 28a via the cylinder 283a, as well as stop means 27b which project from the cylindrical part 27a, and are designed to block the cover 28a in rotation via the cylinder 283a. The stop means 27b advantageously each comprise a rear face, which is situated on the cut-out 21a side, and is designed to receive and support an end face 283a2′ of the cylinder 283a, as well as a front face, which is situated on the hole 21 side, and is designed to receive and support another end face 283a2″ of the cylinder 283a. The stops 27b can for example have a parallelepiped form, in particular a rectangular parallelepiped form. The stop means can comprise two stops 27b which are each arranged at a lateral end of the shaft 27 (FIGS. 19 and 20).

The cylinder 283a is configured to permit both the rotation of the cover 28a, until the latter has reached its end of course position, and blocking of the cover once its end of course position has been reached. For this purpose, the cylinder 283a comprises a first cylindrical portion 283a1 and a second cylindrical portion 283a2. The first cylindrical portion 283a1 has a reduced width, such as to be interposed between the two stops 27b of the rotational shaft 27, which permits rotation of the cylinder 283a around the shaft 27. The second cylindrical portion 283a2 has a width which is greater than that of the first cylindrical portion 283a1, such as to abut against the stops 27b of the rotational shaft 27.

FIG. 21 illustrates the cover 28a shortly after it has been opened. The rotation of the cover 28a takes place around the shaft 27, by simultaneous rotation of the first cylindrical portion 283a1 and the second cylindrical portion 283a2. The rotation stops when the end 283a2′ of the second cylindrical portion 283a2 comes into contact with the vertical rear faces of the stops 27b, thus defining a substantially vertical end of course position of the cover 28a. The blocking of the cover 28a in the end of course position thus takes place before the upper face 281a of the cover is supported against the rear face 21a1 of the cut-out 21 (FIG. 22).

The second cylindrical portion 283a2 advantageously comprises, at the other side of its end face 283a2′, two faces 283a2″ which are each supported against the front face of the stops 27b situated on the hole 21 side, such as to block the cover 28a in its dosed position. By this means, the two support faces of the stops 27b make it possible to ensure blocking of the cover 28a during its opening, in it end of course position P3, then during its closure, in its dosed position P1.

It will be appreciated that the invention is not limited to a unit provided with an articulated cover which is fitted on a streamlined flat wiper, the unit provided with an articulated cover according to the invention being able to be fitted on any other type of wiper, with the articulated cover being designed to cover an opening in the said unit, or adjacent to the said body.

1. A wiper unit for a windscreen wiper comprising:
a body;
an articulated cover, which can be displaced between two extreme positions relative to the body; and
stop means which define an end of course position of the cover, the end of course position being intermediate between the two extreme positions.

2. The wiper unit according to claim 1, wherein the body comprises a hole which is designed to be covered at least partly by the cover, and is extended by a cut-out in which a rotational shaft of the cover is positioned.

3. The wiper unit according to claim 2, wherein the stop means comprise at least one stop projecting on the body.

4. The wiper unit according to claim 3, wherein the at least one projecting stop is arranged spaced apart from the cut-out.

5. The wiper unit according to claim 4, wherein the at least one projecting stop is arranged on the side opposite to the hole.

6. The wiper unit according to claim 2, wherein the stop means comprise an arm of the cover which cooperates with a stop means of the body.

7. The wiper unit according to claim 6, wherein the arm has a curved end which can be supported against or below the stop means of the body during the opening of the cover.

8. The wiper unit according to claim 6, wherein the stop means of the body is arranged inside the hole, on an inner wall of the body.

9. The wiper unit according to claim 6, wherein the cover is provided with two lateral arms which each cooperate with a stop means of the body.

10. The wiper unit according to claim 2, wherein the stop means comprise stop means of a rotary articulation element of the cover which cooperates with stop means of a rotational shaft of the cover.

11. The wiper unit according to claim 10, wherein the rotational shaft of the cover comprises a cylindrical portion and projecting stop means on the cylindrical portion.

12. The wiper unit according to claim 11, wherein the rotational shaft of the cover comprises a cylindrical portion and two stops each arranged at a lateral end of the shaft.

13. The wiper unit according to claim 12, wherein the cover comprises a rotary articulation element provided with a first cylindrical portion arranged between the two stops of the rotational shaft, and a second cylindrical portion which can abut against the two stops of the rotational shaft.

14. The wiper unit according to claim 13, wherein each stop of the rotational shaft comprises a first face, which is situated on the cut-out side, and is substantially orthogonal to the longitudinal axis of the hole, the said first face being designed to block an end surface of the second cylindrical portion in rotation in the direction of opening of the cover.

15. The wiper unit according to claim 14, wherein each stop of the rotational shaft additionally comprises a second face, which is situated on the hole side, and is substantially orthogonal to the longitudinal axis of the hole, the said second face being designed to block the other end surface of the second cylindrical portion in rotation in the direction of closure of the cover.

16. The wiper unit according to claim 1, wherein the wiper unit is a unit for connection of the wiper blade to a wiper arm.

17. The wiper unit according to claim 16, wherein the said wiper unit is a central fitting of a flat streamlined windscreen wiper.

18. A windscreen wiper comprising a wiper unit according to claim 1.

19. The windscreen wiper according to claim 18, further comprising a streamlined portion comprising two end covers and a central fitting which is situated between the two end covers, each end cover being articulated relative to the central fitting.
